(19) United States
(12) Patent Application Publication
(10) Pub. No.: US 2011/0129791 A1
(43) Pub. Date: Jun. 2, 2011

(54) SYSTEMS AND METHODS FOR OBTAINING DENTAL IMPRESSIONS

(76) Inventor: Gary Rabinowitz, New York, NY (US)

(21) Appl. No.: 12/954,762

(22) Filed: Nov. 26, 2010

Related U.S. Application Data
(60) Provisional application No. 61/265,141, filed on Nov. 30, 2009.

(51) Int. Cl. A61C 9/00

(52) U.S. Cl. 433/37; 433/214

(57) ABSTRACT

Certain embodiments of the present invention provide an apparatus to facilitate obtaining a dental impression including a compressible body. The compressible body has a top surface, a bottom surface, and an outer border. The bottom surface is configured to abut a maxillary dental impression tray. The top surface of the compressible body is configured to substantially contact and conform to a surface of a patient's hard palate. As the top surface contacts and conforms to the hard palate, it causes the compressible body to compress. The top surface forms a seal with the patient's hard palate. This seal discourages dental impression material from flowing into the patient's palatal vault. The seal may also discourage the dental impression material from flowing into the back of the patient's mouth. Consequently, the hydrodynamic pressure of the dental impression material may be advantageously increased and the patient's comfort may be reduced. Furthermore, the seal may promote a hydrodynamic flow of the dental impression material against the patient's teeth and into the corresponding gingival sulcus. When the compressible body compresses, the outer border may expand. This expansion may lead to further promotion of the hydrodynamic presser and flow of the dental impression material.

### RELATED APPLICATIONS

This application claims priority to U.S. Provisional Patent Application No. 61/265,141, filed on Nov. 30, 2009, which is herein incorporated by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates generally to controlled flow of dental impression materials. More specifically, it relates to a flexible and/or compressible addition or component in dental impression trays.

Certain dental procedures require castings of dental surfaces. The castings may be formed from dental impression material. In order to obtain or take the casting, the dental impression material may be placed into a tray, such as a maxillary or upper dental tray. The dental impression material may initially be a somewhat viscous liquid or flowing material. A dental impression tray may be loaded with the impression material and inserted in a patient's mouth until the dental impression material has sufficiently solidified, at which time the tray and dental impression material are removed. Once removed from the patient's mouth, the tray with the sufficiently solidified dental impression material contains an impression of the dental surfaces.

Because the dental impression material may be a flowing material, it may flow into areas of a patient's mouth that are not part of the dental surfaces that are to be casted. For example, the dental impression material may flow into a patient's palatal vault or into the back of the mouth towards the throat, which may potentially stimulate a gag reflex. In addition to creating discomfort in a patient, such unwanted flow may cause reduced hydrodynamic pressure of the dental impression material. Such reduction may lead to a degraded casting. For example, there may be an increased chance of “drag”—an unwanted creeping movement of dental impression material.

Furthermore, when taking an impression, it may be desirable to regulate the position of the tray so it does not substantially move during the impression taking process. One problem that may result from inadequate regulation is “over-seating”, in which a patient's teeth sink too close to the bottom of the dental impression tray.

In addition, the surfaces and contours of each patient's mouth vary, which can exacerbate some of these and other concerns.

### BRIEF SUMMARY OF THE INVENTION

Certain embodiments of the present invention provide an apparatus to facilitate obtaining a dental impression including a compressible body. The compressible body has a top surface, a bottom surface, and an outer border. The bottom surface is configured to abut a maxillary dental impression tray. An adhesive may be located on the bottom surface. The adhesive can adhere to the maxillary dental impression tray. A peel-away covering may be provided to removably attach to the adhesive.

The top surface of the compressible body is configured to substantially contact and conform to a surface of a hard palate of a patient. As the top surface contacts and conforms to the hard palate, it causes the compressible body to compress. The outer border of the compressible body contacts a dental impression material in a well of the maxillary dental impression tray.

The top surface forms a seal with the patient's hard palate. This seal discourages dental impression material from flowing into the patient's palatal vault. The seal may also discourage the dental impression material from flowing into the back of the patient's mouth. Consequently, the hydrodynamic pressure of the dental impression material may be advantageously increased and the patient's comfort may be increased. Furthermore, the seal may promote a hydrodynamic flow of the dental impression material against the patient's teeth and corresponding gingival sulcus. When the compressible body compresses, the outer border may expand. This expansion may lead to further promotion of the hydrodynamic pressure and flow of the dental impression material.

The seal may be formed at a location on the hard palate above the gingival margin. For example, the seal may be formed at an elevation approximately ¼ inch from the lingual surfaces of the posterior teeth. This distance may gradually increase as the seal moves towards the anterior of the hard palate. On the anterior side, the seal may be approximately at the Ruggae at the midline of the palate.

The compressible body may be configured to substantially fill the patient's palatal vault when it is fully inserted and compressed. The body may include or be formed from a compressible material such as foam. The body may have a firmness that regulates the compression of the maxillary dental impression tray. The firmness may correspond to a 25% indentation load deflection measure between approximately 5 and 20.

Certain embodiments of the present invention provide an apparatus to facilitate obtaining a dental impression. The apparatus includes a maxillary dental impression tray. The tray has an outer wall, a flexible palate-approximating shape, and a well formed between the outer wall and the flexible palate-approximating shape. The flexible palate-approximating shape is configured to form a seal to discourage dental impression material from flowing into the patient's palatal vault. The palate-approximating shape may also be configured to conform to a surface of the patient's hard palate. The flexible palate-approximating shape may include or be formed with silicone. For example, the palate-approximating shape may be formed as an over-mold portion during an injection molding process.

The seal promotes a hydrodynamic flow of the dental impression material against the patient's teeth and into the corresponding gingival sulcus. The seal may be formed at a location on the hard palate above the gingival margin. For example, the seal may be formed at an elevation approximately ¼ inch from the lingual surfaces of the posterior teeth. This distance may gradually increase as the seal moves towards the anterior of the hard palate. On the anterior side, the seal may be approximately at the Ruggae at the midline of the palate.

Certain embodiments of the present invention provide a method for facilitating the taking of a dental impression. A compressible body is adhered to a palate area of a maxillary dental impression tray. The compressible body is then compressed against the patient's hard palate and a seal is formed. Consequently, dental impression material is discouraged from flowing into the patient's palatal vault. The dental impression material is also discouraged from flowing into the back of the patient's mouth. The compressible body has an outer border that may expand in response to the compression of the compressible body. As a consequence, the hydrodynamic pressure of the dental impression material may be increased.

### BRIEF DESCRIPTION OF SEVERAL VIEWS OF THE DRAWINGS

FIG. 1 shows a maxillary dental impression tray.

FIG. 2A shows a compressible body, according to an embodiment of the present invention.

FIG. 2B shows a compressible body and a peel-away covering, according to an embodiment of the present invention.

FIG. 2C shows a compressible body and a maxillary dental impression tray, according to an embodiment of the present invention.

FIG. 3 shows a cross-section view of an upper maxillary dental impression tray with a compressible body being pressed into a patient's mouth, according to an embodiment of the present invention.

FIGS. 4A and 4B illustrate a flow of dental impression material using a maxillary dental impression tray and a compressible body, according to an embodiment of the present invention.

FIG. 5 shows a compressible body and a maxillary dental impression tray, according to an embodiment of the present invention.

FIGS. 6A-6E illustrate various shapes for a compressible body or a flexible palate-approximating shape, according to embodiments of the present invention.

FIG. 7 shows a flowchart for a method of taking a dental impression, according to an embodiment of the present invention.

The foregoing summary, as well as the following detailed description of certain embodiments of the present invention, will be better understood when read in conjunction with the appended drawings. For the purposes of illustration, certain embodiments are shown in the drawings. It should be understood, however, that the claims are not limited to the arrangements and instrumentality shown in the attached drawings.

### DETAILED DESCRIPTION OF THE INVENTION

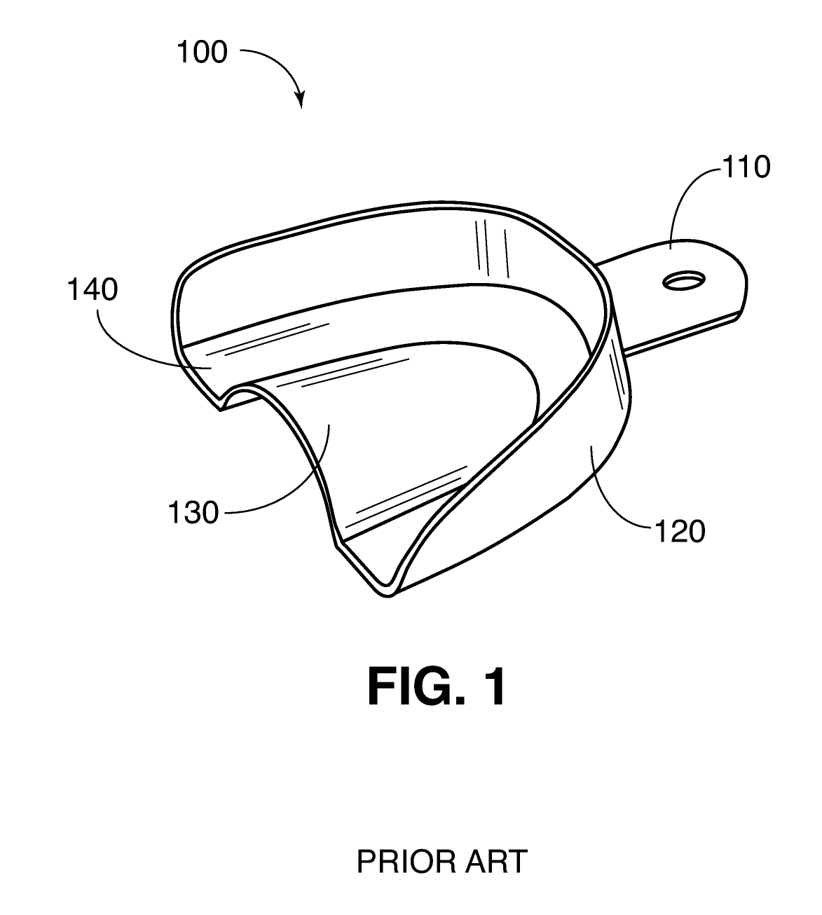

FIG. 1 shows a maxillary dental impression tray 100. The tray may include a handle 110, an outer wall 120, a palate area 130, and a well 140.

The tray 100 is configured to hold dental impression material (not shown) in the well 140. The tray 100 may be used by inserting it into a patient's mouth and pressing upward towards the patient's maxillary teeth or jaw. The handle 110 may be used to facilitate insertion and removal of the tray 100 into the patient's mouth. The well 140 may be generally formed between the outer wall 120 and the palate area 130. Maxillary dental impression trays are known, and as used herein are confined to the specific examples described herein.

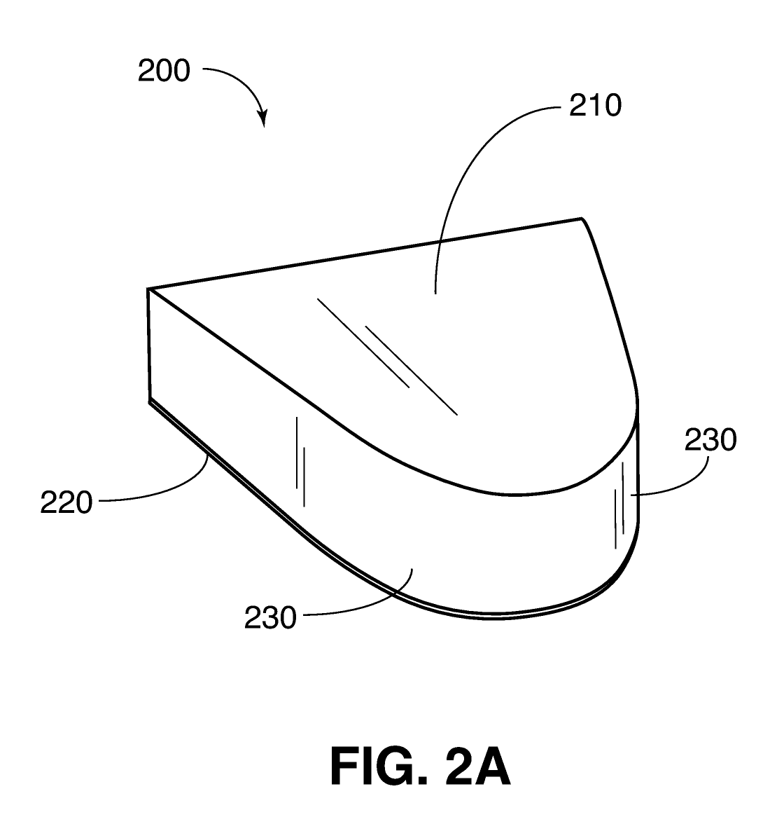

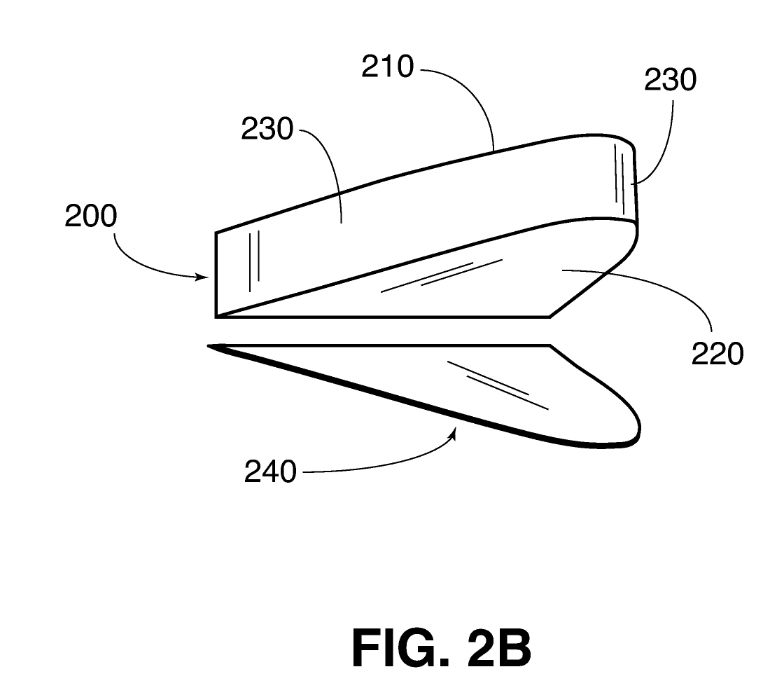

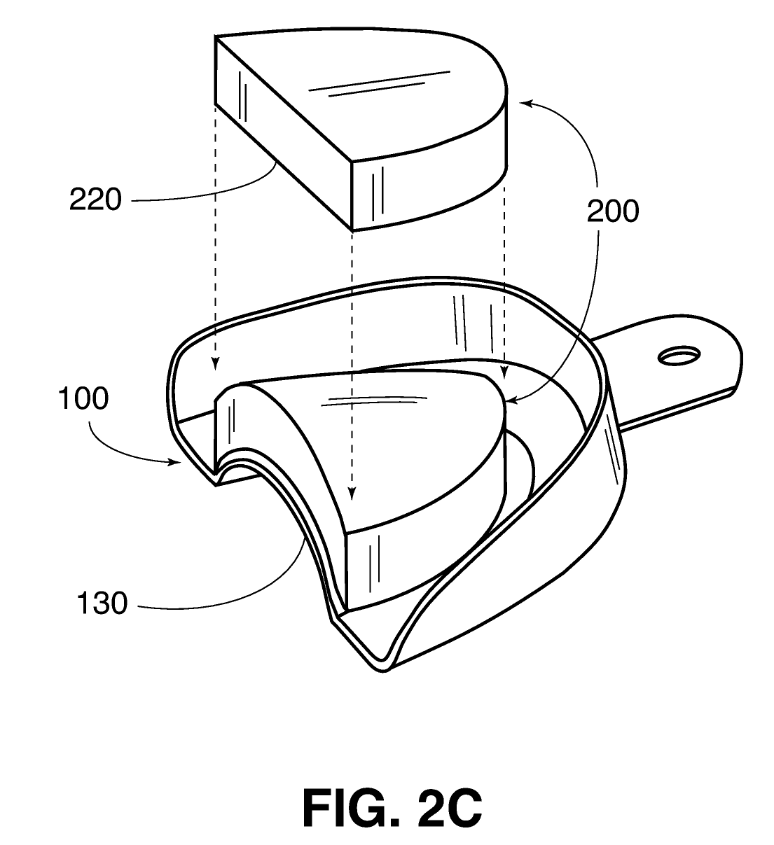

FIG. 2A shows a compressible body 200, according to an embodiment of the present invention. The compressible body 200 may include a top surface 210, a bottom surface 220, and an outer border 230.

The compressible body 200 may include a compressible material, such as foam. For example, the compressible material may include polyurethane foam, silicone foam, memory (viscoelastic) foam, etc. A certain amount of force may be required to compress the compressible body 200. One such measure of quantifying the compressibility or firmness of a material such as foam is called indentation load deflection (“ILD”). To the extent that the term ILD may be used throughout this application and the claims, such a measurement may also correspond to other quantifiable ways of measuring compression. For example, a measure of compression in terms of ILD may also correspond to a measure in terms of indentation force deflection (“IFD”). Ordinary artisans may also appreciate other corresponding ways of measuring compression in the compressible body and that a measurement in one system may be equal to a measurement in another system. The details of IFD or ILD measurements are described in various publications, such as The Joint Industry Foam Standards and Guidelines, July 1994, Section 4.0, which is herein incorporated by reference. As used herein, IFD corresponds to IFD measurements at 25% deflection use. In an embodiment the compressible body IFD is approximately between 5 and 20.

FIG. 2B shows the compressible body 200 and a peel-away covering 240, according to an embodiment of the present invention. There may be an adhesive located on the bottom surface 220 of the compressible body 200. The peel-away covering 240 may be temporarily adhered to the adhesive. Once removed, the adhesive may be adhered to another surface—thereby adhering the compressible body 200 to such other surface. For example, the adhesive may be adhered to a maxillary dental impression tray, such tray 100. Adhesion may be temporary, permanent, semi-permanent, etc.

FIG. 2C shows the compressible body 200 and the maxillary dental impression tray 100, according to an embodiment of the present invention. The compressible body 200 is illustrated as being adhered to the maxillary dental impression tray 100 according to the dotted arrows. As discussed, an adhesive may be located on the bottom surface 220 of the compressible body 200. The adhesive may be configured to adhere to the tray 100. For example, the adhesive may be adhered to the palate area 130 of the maxillary dental tray 100. The outer border 230 of the compressible body 200 may be configured to contact a dental impression material (not shown) in the well 140 of the tray 100 (as depicted, for example, in FIG. 1).

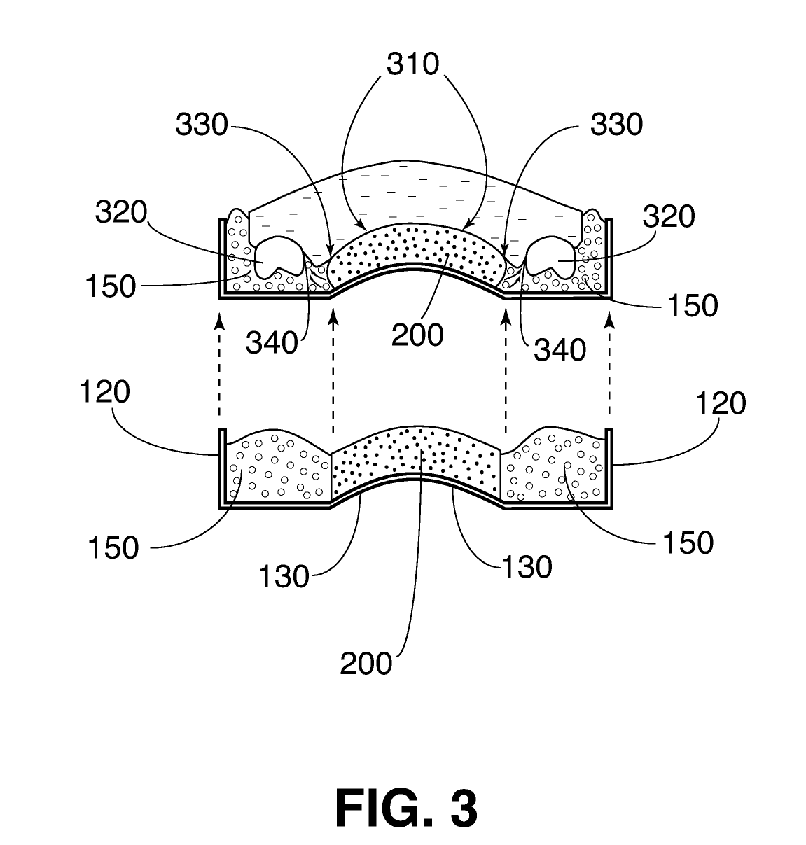

In conjunction with FIGS. 2A-2C, FIG. 3 shows a cross-section view of the maxillary dental impression tray 100 with the compressible body 200 being pressed into a patient's mouth, according to an embodiment of the present invention. The tray 100 and the compressible body 200 are illustrated as being upwardly pressed into the dental surfaces according to the dotted arrows. The pressing may be facilitated by a clinician, such as a dentist, by a patient biting down, and/or by other techniques.

The compressible body 200 is adhered to the tray 100. Dental impression material 150 has been filled into the well 140. The patient's mouth, as illustrated, includes a hard palate 310, teeth 320, and a corresponding gingival sulcus 340. As the tray 100 and compressible body 200 are inserted, the compressible body 200 compresses against the hard palate 310. Because the compressible body 200 may be flexible, it may be able to conform to a variety of different palatal surfaces. Furthermore, the compressible body may be able to adapt to other variances in the anatomy of the mouth or palate. This flexibility may allow the body to substantially avoid interfering with dental structures such as variances in the shape of the palate, or palatal tori. The compressible body 200 may substantially fill the patient's palatal vault.

The top surface 210 of the compressible body 200 may substantially conform to a surface of the hard palate 310, thereby forming a seal 330. As the compressible body 200 is pushed against the hard palate 310, part of the outer border 230 may become part of the top surface 210. It should be understood that the boundary between the top surface 210 and the outer border 230 may dynamically change based on the amount of pressure applied, the contour of a patient's mouth, the material of the compressible body 200, and/or the like.

The seal 330 may substantially discourage the dental impression material 150 from flowing into the patient's palatal vault. The seal may also discourage a flow of the dental impression material 150 into a back of the mouth. Because the dental impression material 150 is constrained by the seal 330, the hydrodynamic pressure of the material 150 within the well 140 of the tray 100 may increase. The seal 330 may also promote a hydrodynamic flow of the dental impression material 150 against the teeth 320 and the gingival sulcus 340. The seal 330 may be formed at an elevation approximately ¼ inch from the lingual surfaces of the teeth posteriorly, measured from the gingival margin, and gradually farther from the lingual surfaces of the teeth as the seal progresses anteriorly, to be at the approximate location of the Ruggae at the midline of the palate.

As the compressible body 200 is compressed, the outer border 230 may expand. Such expansion may further increase or promote the hydrodynamic pressure or the hydrodynamic flow of the dental impression material.

When pressing the tray against the teeth, the dental impression material 150 provides some resistance. This resistance helps to regulate and stabilize the position of the tray 100 during the impression forming process. The compression from the compressible body 200 may provide additional resistance that may further regulate the position of the tray 100. For example, the force required to compress the body 200 may be greater than the force required to compress the dental impression material 150. Through such a technique, it may be possible to reduce issues relating to over seating.

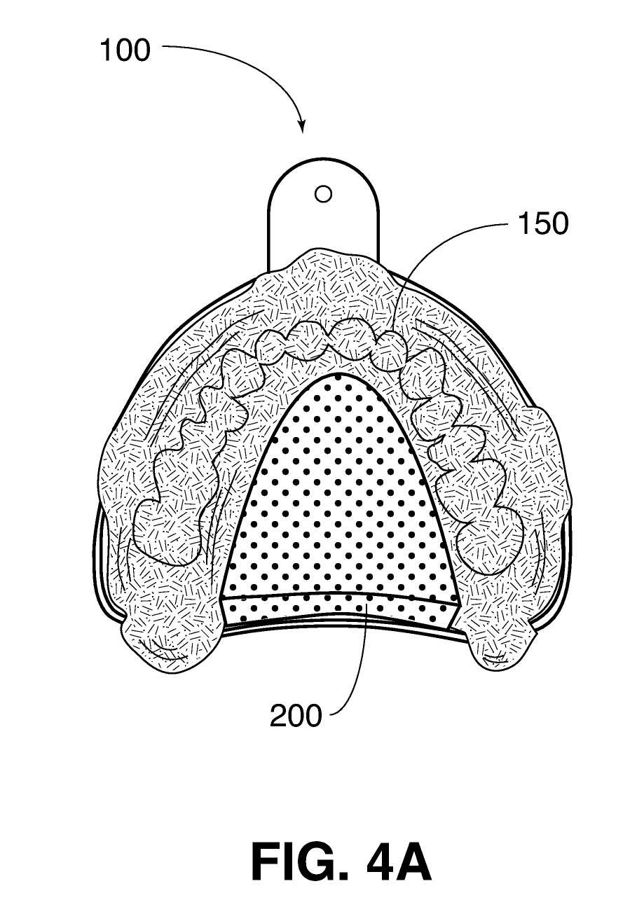

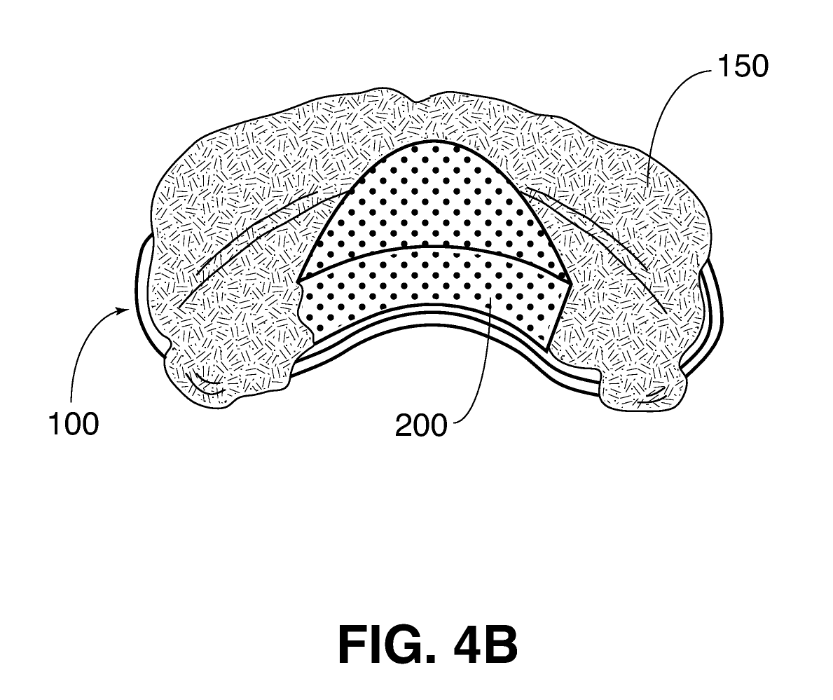

FIGS. 4A and 4B illustrate a flow of dental impression material 150 using a maxillary dental impression tray 100 and a compressible body 200, according to an embodiment of the present invention. FIGS. 4A and 4B illustrate how the dental impression material 150 may appear after removing the tray 100 and the compressible body 200 from the patient's mouth. As seen, the impression material 150 has been formed to reflect certain dental surfaces of the patient. The material 150, however, did not flow substantially into the patient's palatal vault. Nor did the impression material substantially flow to the back of the patient's mouth. The compressible body 200 formed a seal that discouraged such undesired flow of the dental impression material 150.

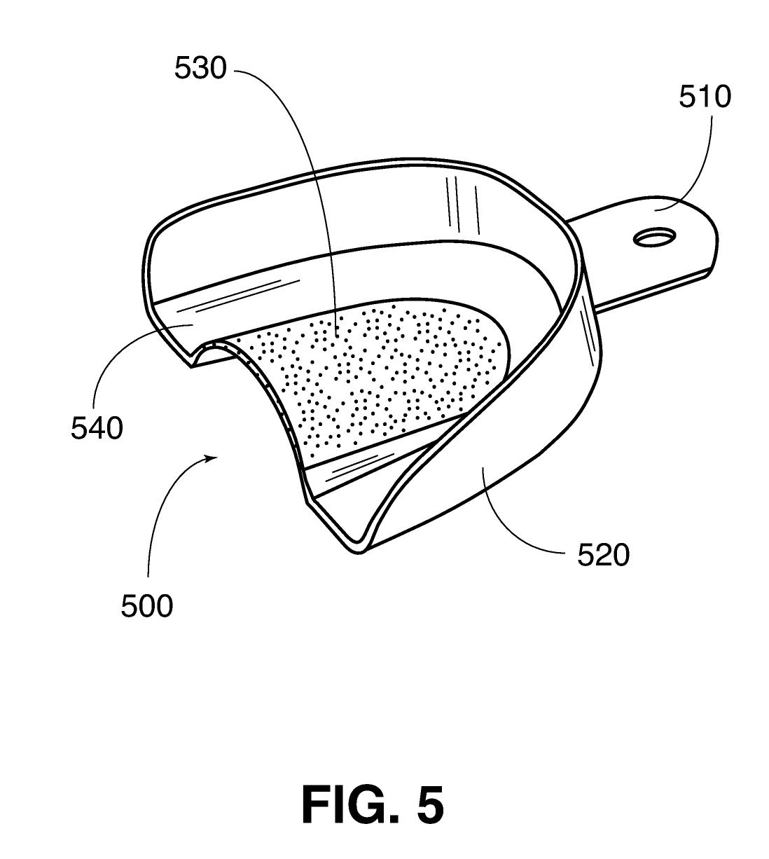

FIG. 5 shows a maxillary dental impression tray 500, according to an embodiment of the present invention. The maxillary dental impression tray 500 includes a handle 510, an outer wall 520, a flexible palate-approximating shape 530, and a well 540. As shown, the well is formed between the outer wall 520 and the flexible palate-approximating shape 530.

In many respects, the maxillary dental impression tray 500 with the flexible palate-approximating shape 530 may be similar to the tray 100 and the compressible body 200 discussed above. When inserting the tray 500 into a patient's mouth, the flexible palate-approximating shape 530 may substantially conform to a surface of the patient's hard palate. The flexible palate-approximating shape 530 may be formed from a material with sufficient rigidity and flexibility (e.g., silicone) to substantially conform to a surface of the hard palate and to compress to provide some regulating resistance, similar to the performance of the compressible body 200 discussed above. Such material may be formed as part of a molding process, such as an over-molding process during injection molding. Thus, the palate-approximating shape 530 may include an over-mold portion.

Like the compressible body 200, the flexible palate-approximating shape 530 may form a seal with the patient's hard palate to discourage unwanted flow (e.g., into the palatal vault or towards the back of the mouth), promote desired hydrodynamic flow (e.g., against teeth and into a corresponding gingival sulcus), and/or improve hydrodynamic pressure of the dental impression material. The seal may be formed at an elevation approximately ¼ inch from the lingual surfaces of the teeth posteriorly, measured from the gingival margin, and gradually farther from the lingual surfaces of the teeth as the seal progresses anteriorly, to be at the approximate location of the Ruggae at the midline of the palate. Furthermore, when compressed, an outer border of the palate-approximating shape 530 may expand, thereby further improving hydrodynamic pressure and/or flow of the dental impression material.

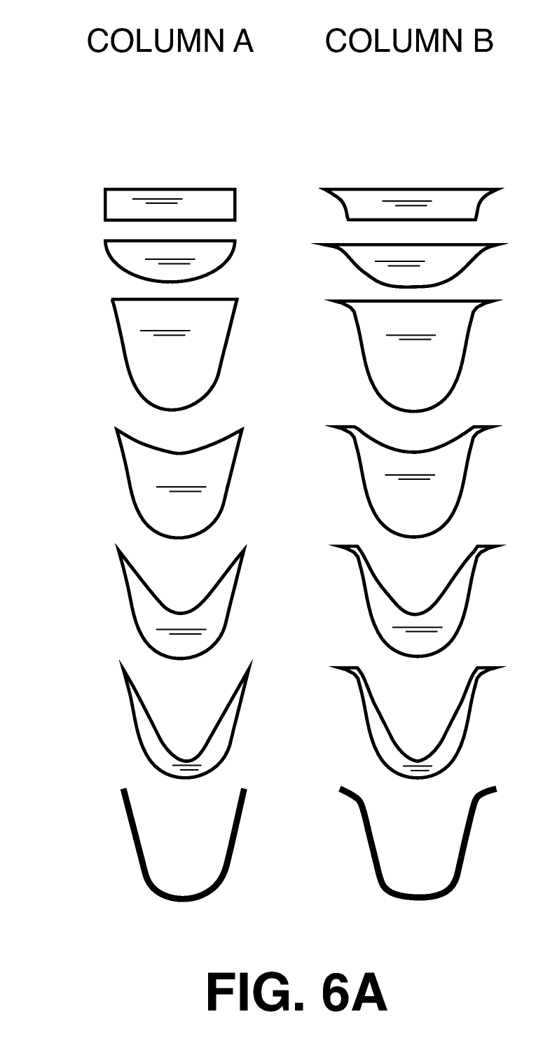

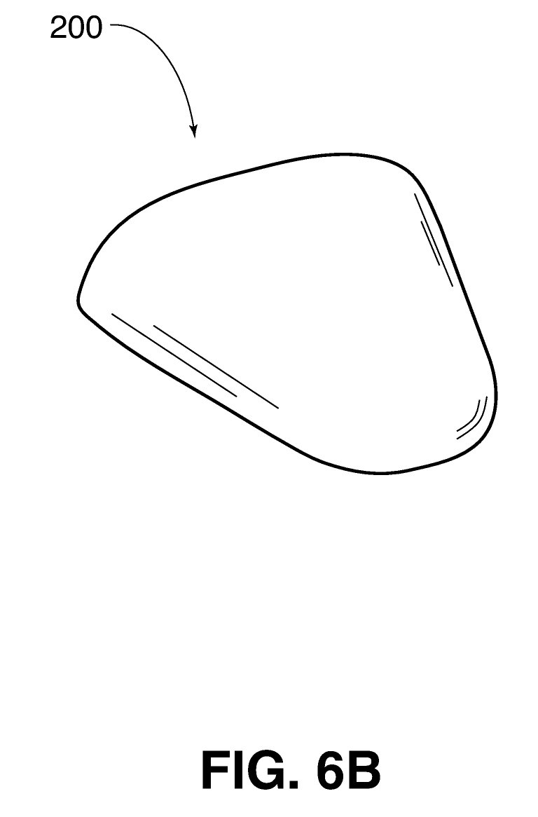

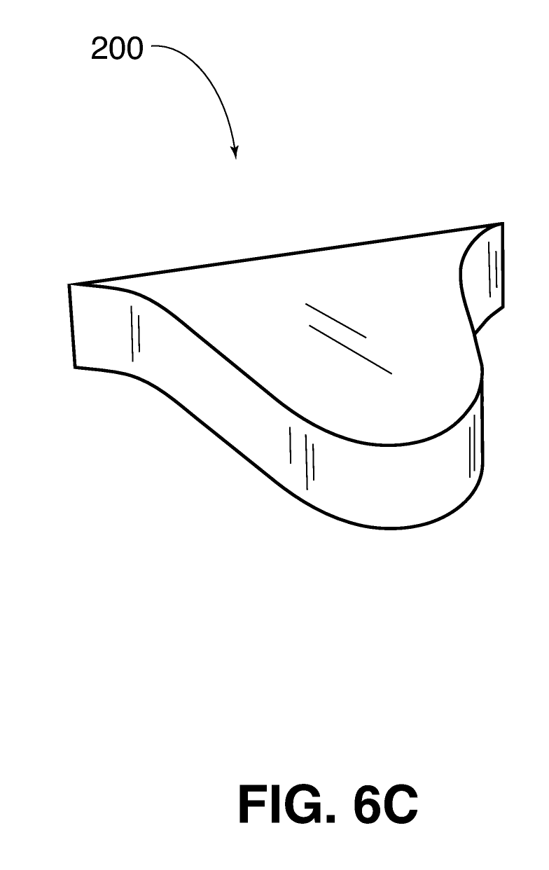

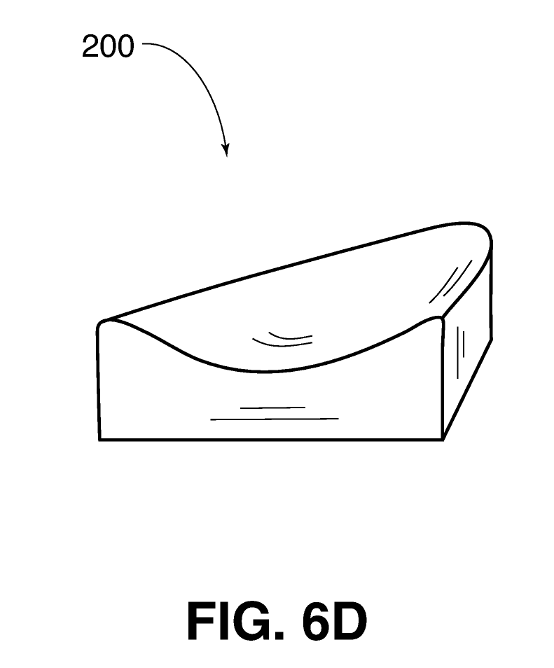

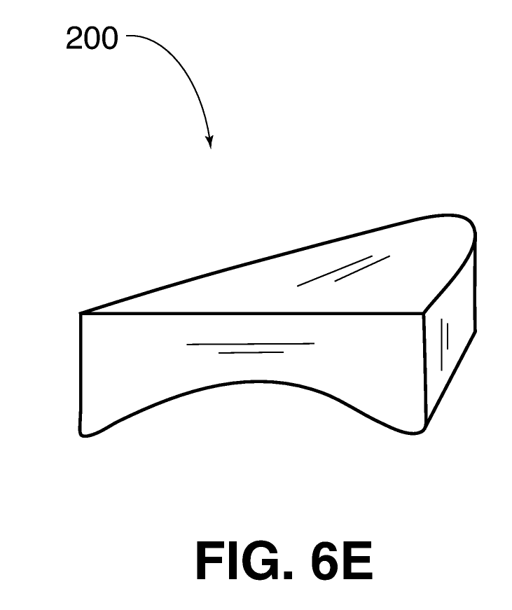

FIGS. 6A-6E illustrate various shapes for a compressible body or a flexible palate-approximating shape, according to embodiments of the present invention. FIG. 6A shows a top view of various compressible bodies or flexible palate-approximating shapes. As can be seen, a wide variety of shapes can be used. Some of the illustrated shapes do not have material in an inner area, or may have portions cut away. Such a shape may assist in sizing the compressible body or the flexible palate-approximating shape. For example, if the compressible body has a portion of the inner area cut away or empty, it may be possible to adjust the body (for example, adjust the width of the body) before adhering or connecting the body to a dental impression tray (see, for example, step 710 discussed below).

FIGS. 6B-6E show different shapes of a compressible body 200. The top surface of the body 200 may be flat, concave, convex, or a mix thereof. The bottom surface of the body 200 may also be flat, concave, convex, or a mix thereof. The same type of variance may also be available for the outer border of the body 200.

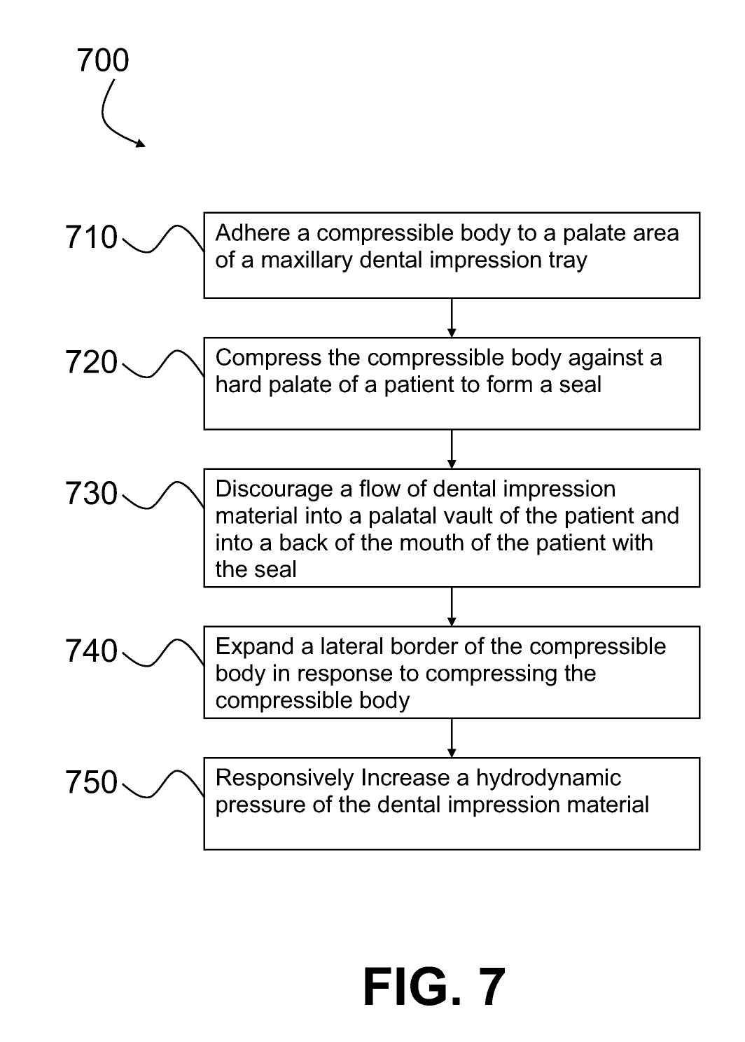

FIG. 7 shows a flowchart 700 for a method of taking a dental impression, according to an embodiment of the present invention. Certain steps in the flowchart 700 may be omitted, while others may be added. The steps may be performed in a different order, or in parallel. The method illustrated by the flowchart 700 may be performed using the apparatuses and techniques discussed above.

At step 710, a compressible body is adhered to the palate area of a maxillary dental impression tray. The compressible body may have an adhesive located on its bottom surface and a peel-away covering on the adhesive. The peel-away covering may be removed and the adhesive may be employed to adhere the compressible body to the maxillary dental impression tray. The compressible body may be adhered to the palate area or to other portions of the tray. At step 720, the compressible body is compressed against a hard palate of a patient to form a seal. For example, a dental clinician may insert the tray into a patient's mouth and push upwards, thereby causing the compressible body to compress against the patient's hard palate. The compression of the body against the hard palate forms a seal. At step 730, the seal discourages dental impression material from flowing into the patient's palatal vault and/or back of the mouth.

At step 740, an outer border of the compressible body expands in response to the compression. At step 750, the hydrodynamic pressure of the dental impression material is increased in response to the border expansion.

As an illustrative example, the method illustrated by flowchart 700 may be performed in the following manner. A dentist desires to obtain a casting of a patient's upper teeth. The dentist takes a compressible body and optionally trims the body with a trimming instrument, such as a scissors to a desired shape. In this example, the compressible body is a piece of foam. Furthermore, the compressible body has an inner area cut away. The dentist removes a peel-away covering over the bottom surface of the body to expose an adhesive. The dentist then places the bottom surface of the compressible body onto a palatal area of a maxillary dental impression tray. Because the compressible body has an inner area cut away, the dentist was able to adjust the width of the compressible body before placing it onto the palatal area. The compressible body is now adhered to the tray. Subsequently, the dentist adds the dental impression material into a well of the tray formed between the outer wall and the compressible body.

Once the tray and compressible body have been prepared, the dentist inserts the tray into the patient's mouth and presses upwards or asks the patient to bite down. The compressible body is forced upwards towards the patient's hard palate and then substantially conforms to a surface to form a seal. The force required to compress the compressible body is greater than the force required to compress the dental impression material. The compressed body exerts a substantially downwards force that helps regulate and stabilize the dental impression tray during the impression taking process.

Additionally, the compressed body substantially conforms to the patient's unique anatomy. The flexible nature of the body also prevents interference with dental structures, such as the patient's mal-positioned tooth or palatal tori.

When the tray is inserted, the dental impression material begins to flow on, into, and around the patient's dental surfaces, including teeth and a corresponding gingival sulcus. The seal, however, discourages the material from flowing into the patient's palatal vault. The seal also discourages the material from flowing towards the back of the patient's mouth. This has at least four advantageous effects. First, the flow of material is constrained and does not substantially flow outside of the desired areas. Second, the patient's comfort is increased, especially because material is discouraged from flowing into areas of the patient's mouth that may cause a gag reflex or other discomfort. Third, the hydrodynamic pressure and flow of the impression material is promoted to make a more precise mold which better resists degrading factors such as over-seating and drag. Note, the regulating force from the compressed body may also help to reduce the effects of such degrading factors. Fourth, less dental impression material is needed since unwanted flow has been discouraged.

Furthermore, as the body compresses, the outer border of the body expands. This expansion further promotes the hydrodynamic flow and pressure of the dental impression material, thereby allowing for additional benefit.

After molding the dental impression material, the dentist removes the tray from the patient's mouth. Once the procedure is over and the impression has been made, the dentist has the option of disposing the tray and/or the compressible body. For example, the dentist can remove the compressible body and throw it away while keeping the tray.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An apparatus to facilitate obtaining a dental impression, the apparatus comprising:
a compressible body;
a bottom surface of the compressible body configured to abut a maxillary dental impression tray;
an outer border of the compressible body configured to contact a dental impression material in a well of the maxillary dental impression tray; and
a top surface of the compressible body configured to:
substantially contact and conform to a surface of a hard palate of a patient;
cause a compression of the compressible body.

2. The apparatus of claim 1 further comprising an adhesive located on the bottom surface and configured to adhere to the maxillary dental impression tray.

3. The apparatus of claim 2, further comprising a peel-away covering removably attached to the adhesive.

4. The apparatus of claim 1, wherein the outer border is configured to expand in response to the compression of the compressible body and to increase a hydrodynamic pressure of the dental impression material.

5. The apparatus of claim 1, wherein the top surface is further configured to form a seal with the hard palate of the patient to discourage a flow of dental impression material into a palatal vault of the patient.

6. The apparatus of claim 5, wherein the top surface is further configured to form the seal to promote a hydrodynamic pressure of the dental impression material and to promote a hydrodynamic flow of the dental impression material against teeth of the patient and into a corresponding gingival sulcus of the patient.

7. The apparatus of claim 5, wherein the top surface is further configured to form the seal to discourage a flow of the dental impression material into a back of the mouth of the patient.

8. The apparatus of claim 5, wherein the compressible body is configured to form the seal at an elevation approximately ¼ inch from the lingual surfaces of the teeth posteriorly, measured from the gingival margin, and gradually farther from the lingual surfaces of the teeth as the seal progresses anteriorly, to be at the approximate location of the Ruggae at the midline of the palate.

9. The apparatus of claim 1, wherein the compressible body is configured to substantially fill the palatal vault of the patient.

10. The apparatus of claim 1, wherein the compressible body comprises foam.

11. The apparatus of claim 1, wherein the compressible body comprises a firmness corresponding to a 25% indentation load deflection between approximately 5 and 20.

12. An apparatus to facilitate obtaining a dental impression, the apparatus comprising:
a maxillary dental impression tray including:
an outer wall;
a flexible palate-approximating shape; and
a well formed between the outer wall and the flexible palate-approximating shape and configured to contain a dental impression material,
wherein the flexible palate-approximating shape is configured to form a seal to discourage a flow of dental impression material into a palatal vault of the patient.

13. The apparatus of claim 12, wherein the flexible palate-approximating shape is configured to promote a hydrodynamic flow of the dental impression material against teeth of the patient and into a gingival sulcus of the patient.

14. The apparatus of claim 12, wherein the flexible palate-approximating shape is further configured to form the seal to discourage a flow of the dental impression material towards a back of the mouth of the patient.

15. The apparatus of claim 12, wherein the flexible palate-approximating shape is further configured to form a seal at an elevation of the hard palate approximately ¼ inch from the lingual surfaces of the teeth posteriorly, measured from the gingival margin, and gradually farther from the lingual surfaces of the teeth as the seal progresses anteriorly, to be at the approximate location of the Ruggae at the midline of the palate.

16. The apparatus of claim 12, wherein the flexible palate-approximating shape comprises silicone.

17. The apparatus of claim 12, wherein the palate-approximating shape comprises an over-mold portion.

18. The apparatus of claim 12, wherein the palate-approximating shape is configured to conform to a surface of a hard palate of the patient.

19. A method for facilitating the taking of a dental impression, the method comprising:
adhering a compressible body to a palate area of a maxillary dental impression tray;
compressing the compressible body against a hard palate of a patient to form a seal;
discouraging a flow of dental impression material into a palatal vault of the patient and into a back of the mouth of the patient with the seal.

20. The method of claim 19, further comprising:
expanding an outer border of the compressible body in response to compressing the compressible body; and
responsively increasing a hydrodynamic pressure of the dental impression material.
